(19) United States
(12) Patent Application Publication
(10) Pub. No.: US 2025/0316776 A1
(43) Pub. Date: Oct. 9, 2025

(54) BATTERY SYSTEM AND BATTERY COMMUNICATION SYSTEM THEREOF

(71) Applicant: Grace Connection Microelectronics Limited, Zhubei (TW)

(72) Inventor: Pei Wei Chen, Zhubei (TW)

(73) Assignee: Pei Wei Chen, Zhubei (TW)

(21) Appl. No.: 19/088,897

(22) Filed: Mar. 24, 2025

(30) Foreign Application Priority Data
Apr. 3, 2024 (TW) 113112749

(51) Int. Cl. H01M 10/42; H01M 10/48

(52) U.S. Cl. CPC H01M 10/425; H01M 10/482; H01M 2010/4278

(57) ABSTRACT

A battery system and a battery communication system thereof, are provided by the present invention. The battery communication system includes: at least one monitoring chip, a controller and at least one radio frequency coupler. The monitoring chip is connected to at least one battery cell. The radio frequency coupler is disposed adjacent to the monitoring chip, or disposed between the monitoring chip and the controller.

### CROSS REFERENCE

The present invention claims priority to TW113112749 filed on Apr. 3, 2024.

### BACKGROUND OF THE INVENTION

### Field of Invention

The present invention relates to an electronic system, in particular to a battery system and its battery communication system.

### Description of Related Art

For power efficiency of battery power storage systems, the batteries in current industrial and automotive battery power storage systems are mainly connected in series. The DC voltage through the battery series, increases as the number of battery cells connected in series increases. However, the battery power storage systems should be able to monitor/collect voltage information and temperature information of each battery cell, to keep the battery to be safe during operation. As the DC voltage value across the series connection increases, the voltage drop across the battery power storage communication system increases, and the challenges to maintain the safety and stability of the battery storage communication system also increase.

Regarding the commonly used LiFePO4 batteries or lithium phosphate batteries, its battery discharge curve is smoother than other kinds of batteries, so that it needs more accurate monitoring over battery parameters to manage the battery power storage system, especially for the energy capacity of a single battery from ampere-hours (2-3 Ah) to hundred ampere-hours (200-300 Ah) in the discharge process. Based on this accurate monitoring necessity, the current battery power storage systems have a trend to arrange a monitoring chip to cooperate with a battery unit.

Traditionally, capacitive coupling in series connection or inductive coupling in parallel connection, can be utilized to isolate the voltages between the batteries. However, capacitive coupling in series has a lower reliability to possibly affect the safety of the battery power storage system. The inductive coupling in parallel must be able to withstand the high voltage accumulated across the series connection of the batteries, and the reliability of the components can substantially affect the safety of the battery power storage system. In communication system for parallel connection, the communication collision between different communication ports and the main control chips often affects the stability of communication. It is not easy to confirm the position and disposition sequence of batteries, which can cause difficulties in assembly and maintenance.

### SUMMARY OF THE INVENTION

The present invention relates to a battery system and its battery communication system, which utilizes a radio frequency coupler or an optical transceiver in the communication of a battery pack with a series connection arrangement to improve reliability and avoid communication collisions.

According to one perspective of the present invention, a battery communication system is provided. The battery communication system includes at least one monitoring chip, a controller, and at least one radio frequency coupler. The monitoring chip is connected to a battery cell. The radio frequency coupler is disposed adjacent to the monitoring chip, or disposed between the monitoring chip and the controller.

According to another perspective, a battery system of the present invention, includes: at least one battery cell and a battery communication system. The battery communication system includes at least one monitoring chip, a controller, and at least one radio frequency coupler. The monitoring chip is connected to a battery cell. The radio frequency coupler is disposed adjacent to the monitoring chip, or disposed between the monitoring chip and the controller.

The objectives, technical details, features, and effects of the present invention will be better understood with regard to the detailed description of the embodiments below, with reference to the attached drawings.

### BRIEF DESCRIPTION OF THE DRAWINGS

FIG. 1 shows a schematic diagram of a battery system and its battery communication system according to one embodiment of the present invention.

FIG. 2 shows a schematic diagram of a radio frequency coupler according to one embodiment of the present invention.

FIG. 3 shows the connection between the radio frequency coupler and the monitoring chip according to one embodiment of the present invention.

FIG. 4 shows another battery system and its battery communication system according to one embodiment of the present invention.

FIG. 5 shows a schematic diagram of the optical transceiver according to one embodiment of the present invention.

FIG. 6 shows the connection between the optical transceiver and the monitoring chip according to one embodiment of the present invention.

FIG. 7 shows the signal transmission between the optical transceivers according to one embodiment of the present invention.

FIG. 8 shows the signal transmission between the optical transceiver according to another embodiment of the present invention.

### DESCRIPTION OF THE PREFERRED EMBODIMENTS

The technical wordings in this specification are based on customary understanding in the art. When the wording is described or defined in this specification, the interpretation of that wording is preferentially based on the description or the definition in this specification. Each embodiment of the present invention includes one or more technical features. To the extent possible, a person having ordinary knowledge in the art may combine or modify some or all of the technical features in any of the embodiments, within the spirit of the present invention.

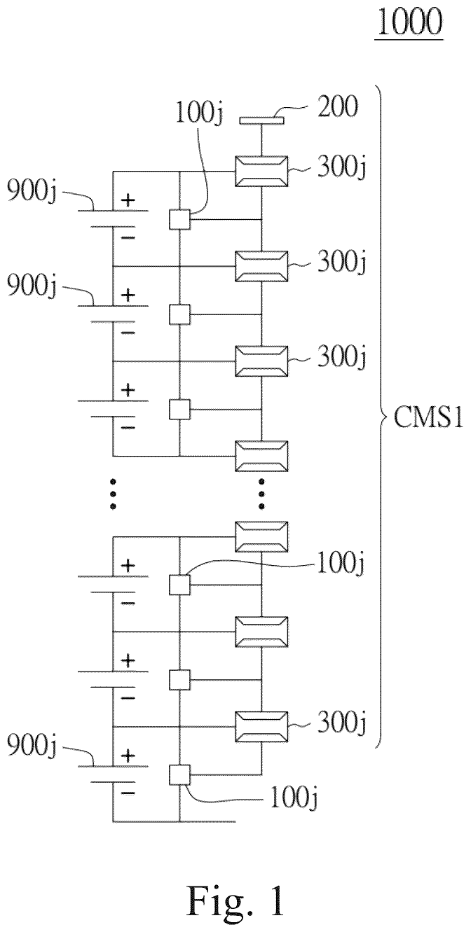

Please refer to FIG. 1, which shows a battery system 1000 and a battery communication system CMS1 according to one embodiment of the present invention. The battery system 1000 includes several battery cells 900j and a battery communication system CMS1. In one embodiment, the number of battery cells 900j can be one. The battery cell 900j is, for example, a lithium phosphate battery or a lithium ternary battery. The battery cells 900j are connected in series. When the battery system 1000 is in operation, the battery cells 900j are monitored to verify whether the temperature, voltage, and other battery parameters are normal or not. In particular, in the case of the battery cell 900j employing lithium phosphate batteries with a relative smooth battery discharge curve, it is necessary to dispose a monitoring chip 100j for precisely monitoring each battery cell 900j. In one embodiment, the number of the monitoring chip 100j can be one.

As shown in FIG. 1, the battery communication system CMS1 includes the above-mentioned monitoring chip 100j, a controller 200, and several radio frequency couplers 300j. In one embodiment, the number of the radio frequency couplers 300j can be only one, wherein one monitoring chip 100j is connected to one battery cell 900j. In particular, one monitoring chip 100j is one-on-one connected to one battery cell 900j. The number of radio frequency couplers 300j can be the same as the number of monitoring chips 100j.

A controller 200 can be employed to control these monitoring chips 100j to collect monitoring information. The radio frequency coupler 300j is disposed between two adjacent monitoring chips 100j, or disposed between the first monitoring chip 100j and the controller 200. A wireless whisper communication of the present invention can be operated between the controller 200 and the first monitoring chip 100j, and between the nearest monitoring chips (from the first monitoring chip 100j to the last monitoring chip 100j) respectively connected with the radio frequency couplers 300j, for transmitting commands to the monitoring chip 100j or sending back the monitoring information from the monitoring chip 100j. These radio frequency couplers (RF couplers) are employed to form a daisy chain communication path.

According to the present invention, the wireless whisper communication between the radio frequency couplers 300j, is effective only for communication between the two ends of the neighboring radio frequency couplers 300j, and does not interfere in nor cause the communication with other farther radio frequency couplers. The radio frequency coupler 300j herein, can be interfered with none of other farther radio frequency couplers except the neighboring radio frequency coupler 300j.

The controller 200 can be: for example, a circuit, a circuit board, a device for storing program code, or a chip. The chip can be: for example, a central processing unit (CPU), a general-purpose or special-purpose programmable micro control unit (MCU), a microprocessor, a digital signal processor (DSP), a programmable controller, an application specific integrated circuit (ASIC), a graphics processing unit (GPU), an image signal processor (ISP), an image processing unit (IPU), an arithmetic logic unit (ALU), a complex programmable logic device (CPLD), a field programmable logic device (FPLD), other similar components, or combinations of the aforementioned components.

In one embodiment, the controller 200 can be time-calibrated according to a master computer or a master server, so that the controller 200 has standardized time information. The controller 200 can transmit a time calibration signal to the monitoring chips 100j through the radio frequency couplers 300j, and the monitoring chips 100j synchronize their internal circuit time based on the time calibration signal.

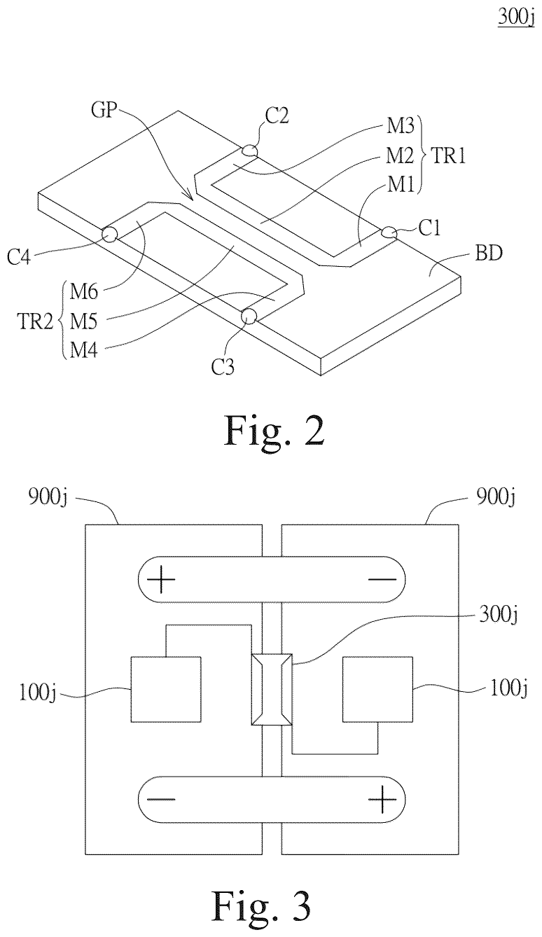

Please refer to FIGS. 2 and 3, wherein FIG. 2 shows a schematic diagram of the radio frequency coupler 300j according to one embodiment of the present invention. FIG. 3 shows the connection between the radio frequency coupler 300j and the monitoring chip 100j according to one embodiment of the present invention. The radio frequency coupler 300j employs wireless whisper communication technology. Each of the radio frequency couplers 300j includes, for example, a circuit board BD, a first communication circuit TR1, and a second communication circuit TR2. The first communication circuit TR1 is disposed on the circuit board BD. The second communication circuit TR2 is set on the circuit board BD. The first communication circuit TR1 and the second communication circuit TR2 are connected to their adjacent monitoring chips 100j respectively.

The first communication circuit TR1 and the second communication circuit TR2 of the radio frequency coupler 300j, are separated by a gap GP to be not directly connected. The dielectrics between the circuit board BD, such as air, can withstand the high voltage accumulated through the series connection of the battery cells 900j to improve operational safety.

In one embodiment, the circuit board BD of the radio frequency coupler 300j can be a flexible-printed circuit. The design of the flexible-printed circuit can undertake the disposition offset and/or vibration between the battery cells 900j, to improve the reliability of the connection between the radio frequency couplers 300j.

As shown in FIGS. 2 and 3, the first communication circuit TR1 of the radio frequency coupler 300j includes, a first node C1 and a second node C2. The second communication circuit TR2 of the radio frequency coupler 300j includes, a third node C3 and a fourth node C4. The first node C1 and the fourth node C4 are respectively connected to the adjacent monitoring chips 100j. The first node C1 and the fourth node C4 serve as the feeding nodes of the adjacent monitoring chips 100j. The first node C1 and the fourth node C4, for example, are disposed at the farthest distance in both of the first communication circuit TR1 and the second communication circuit TR2.

As shown in FIG. 2, the first communication circuit TR1 of the radio frequency coupler 300j includes: for example, a U-shaped structure. The second communication circuit TR2 of the radio frequency coupler 300j also includes; for example, another U-shaped structure. In one embodiment, the first communication circuit TR1 of the radio frequency coupler 300j includes a first metal wire M1, a second metal wire M2, and a third metal wire M3. The first metal wire M1, the second metal wire M2 and the third metal wire M3 are connected in sequence. The first metal wire M1 is substantially perpendicular to the second metal wire M2, and the second metal wire M2 is substantially perpendicular to the third metal wire M3, to form the U-shaped structure.

The radio frequency coupler 300j of the second communication circuit TR2 includes a fourth metal wire M4, a fifth metal wire M5 and a sixth metal wire M6. The fourth metal wire M4, the fifth metal wire M5 and the sixth metal wire M6 are connected in sequence. The fourth metal wire M4 is substantially perpendicular to the fifth metal wire M5, and the fifth metal wire M5 is substantially perpendicular to the sixth metal wire M6, to form the U-shaped structure.

The second metal wire M2 and the fifth metal wire M5 of the radio frequency coupler 300j are separated by the above-mentioned gap GP, to have an indirect connection. This gap GP is sufficient to provide sufficient voltage endurance capability to improve operational safety.

In one embodiment, the first communication circuit TR1 and the second communication circuit TR2 can have the same structural design in the same dimensions. For example, the widths of the first metal wire M1, the second metal wire M2, the third metal wire M3, the fourth metal wire M4, the fifth metal wire M5 and the sixth metal wire M6 can be substantially the same. The lengths of the first metal wire M1, the third metal wire M3, the fourth metal wire M4, and the sixth metal wire M6 of the radio frequency coupler 300j can be substantially the same. The lengths of the second metal wire M2 and the fifth metal wire M5 can be substantially the same.

In the above embodiments, the battery system 1000 and its battery communication system CMS1 employ the radio frequency couplers 300j to transmit commands and monitoring information. The monitoring chips 100j connected to the battery cells 900j, have communication connection with each other by the radio frequency couplers 300j operating in a near-field coupling mode, to form radio frequency whisper communication. Compared to traditional wireless broadcasting technology, the above embodiments of the present invention can avoid network communication collision and the impact of jamming signals in the air, to enable safe and stable communication between battery cells 900j. Moreover, the signal strength in the radio frequency wireless whisper communication can be low enough, to enable the individual position and the disposition sequence of each transmission source to be identified in the battery system, and it can reduce the difficulty of assembly test and maintenance. The first communication circuit TR1 and the second communication circuit TR2 of the radio frequency coupler 300j are not directly connected/contacted. The dielectrics between the circuit board BD, such as air, can withstand the high voltage accumulated across the series connection of the battery cells 900j to improve operational safety.

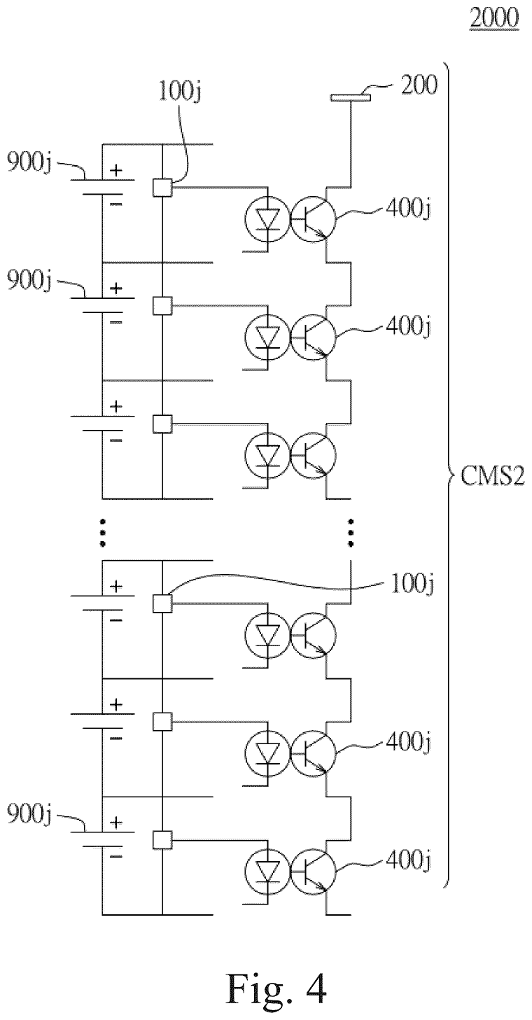

As shown in FIG. 4, the schematic diagram of a battery system 2000 and its battery communication system CMS2 are shown according to one embodiment of the present invention. In FIG. 4, the battery communication system CMS2 includes the above-described monitoring chips 100j, the above-described controller 200, and several optical transceivers 400j. In one embodiment, the number of optical transceivers 400j can be only one. One monitoring chip 100j can be connected to one battery cell 900j. Each of the optical transceivers 400j can be respectively connected to one monitoring chip 100j or one controller 200. The communication between two of the controller 200 and the monitoring chips (from the first monitoring chip 100j to the last monitoring chip 100j), can be separately operated by the two corresponding optical transceivers 400j in series connection, by the wireless whisper communication. Therein, the wireless whisper communication can be employed between the optical transceivers 400j, to transmit commands to the monitoring chip 100j and sending back the monitoring information from the monitoring chip 100j. With the wireless whisper communication, these optical transceivers 400j can form a daisy chain communication path.

The wireless whisper communication between the two corresponding optical transceivers 400j is only effective for these two optical transceivers 400j during communication, without interfering with the other optical transceiver 400j nor being interfered by the other optical transceiver 400j.

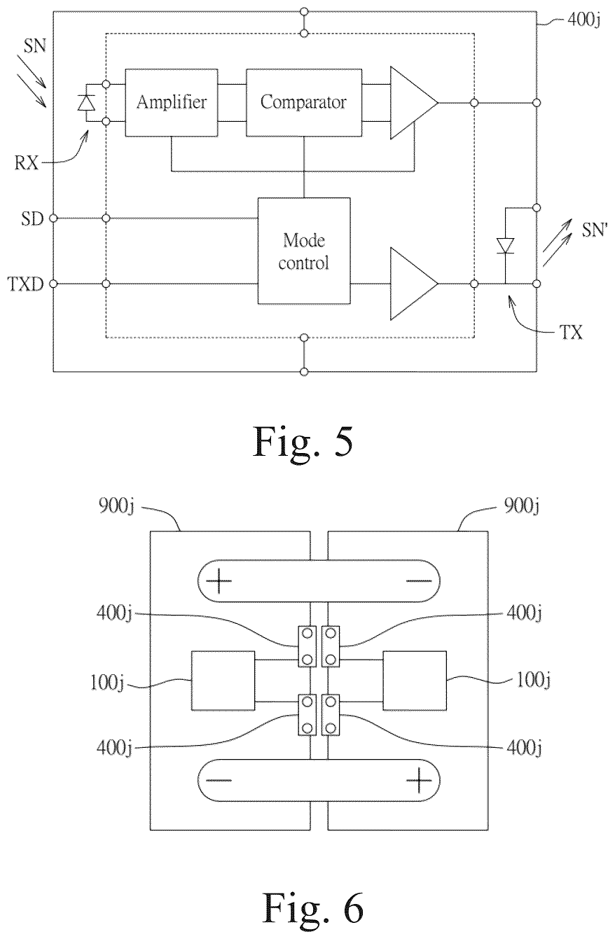

Please refer to FIGS. 5 and 6. FIG. 5 shows a schematic diagram of the optical transceiver 400j according to one embodiment of the t invention, and FIG. 6 shows a connection between the optical transceivers 400j and the monitoring chips 100j according to one embodiment of the present invention. As shown in FIG. 5, the optical transceiver 400j includes an optical receiving unit RX and an optical transmitting unit TX. The optical receiving unit RX can receive an optical communication signal SN. The optical transmitting unit TX can transmit another optical communication signal SN′.

As shown in FIG. 6, one monitoring chip 100j is connected to two optical transceivers 400j, for example. When the number of monitoring chips is N, the last monitoring chip 100j can be connected to only one optical transceiver 400j, and the number of the optical transceivers 400j is 2N−1, wherein N is a natural number.

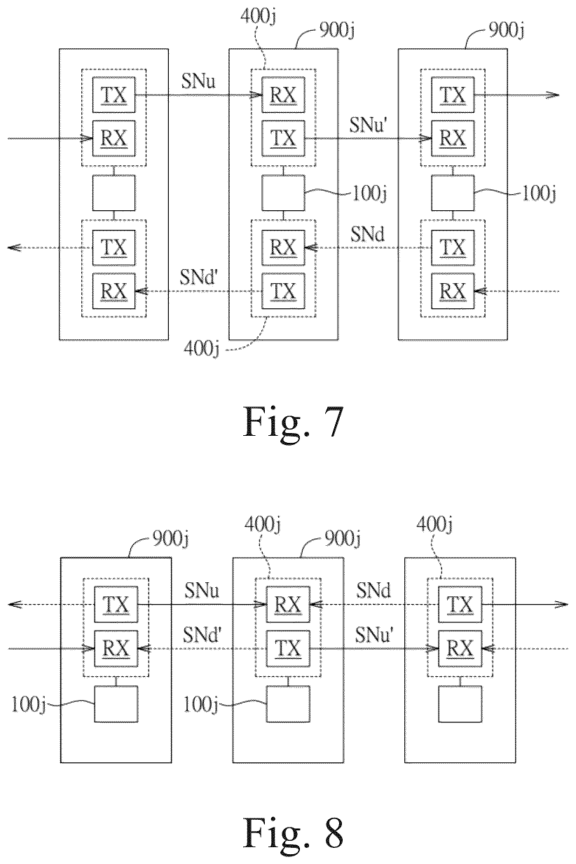

Please refer to FIG. 7, which shows one embodiment of signal transmission between the optical transceivers 400j. In the design of one monitoring chip 100j connected to two optical transceivers 400j, one optical transceiver 400j can be employed for uplink communication, and the other optical transceiver 400j can be employed for downlink communication.

The optical transceiver 400j for uplink communication includes one optical receiving unit RX for receiving one uplink optical communication signals SNu and one optical transmitting unit TX for transmitting another uplink optical communication signal SNu′.

The optical transceiver 400j for downlink communication, includes one optical receiving unit RX for receiving one downlink optical communication signals SNd and one optical transmitting unit TX for transmitting the other downlink optical communication signal SNd′.

In one embodiment, one monitoring chip 100j can be connected to one optical transceiver 400j, wherein the number of optical transceivers 400j is the same as the number of the monitoring chips 100j.

Please refer to FIG. 8, which shows one embodiment of the signal transmission of the optical transceivers 400j. In the design of one monitoring chip 100j connected to one optical transceiver 400j, the optical transceiver 400j must include both uplink and downlink communication functions. For example, each of the optical transceivers 400j includes: the optical receiving unit RX, for receiving the uplink optical communication signal SNu or receiving a downlink optical communication signal SNd; and the optical transmitting unit TX, for transmitting the uplink optical communication signal SNu′ or transmitting the downlink optical communication signal SNd′.

In the design of one monitoring chip 100j connected to one optical transceiver 400j, no communication collision will occur as long as the uplink and downlink communications are operated by the same optical transceiver 400j at different times.

According to the above-mentioned embodiments, the battery system 2000 and its battery communication system CMS2, employ the optical transceivers 400j to transmit commands and the monitoring information. The monitoring chips 100j of the battery cells 900j are connected to each other by the optical transceivers 400j to establish an optical whisper communication. Compared to traditional wireless broadcasting technology, the embodiments of the present invention are capable of reducing the possibility of the network communication collisions and the impact of jamming signals in the air, to provide safe and stable communication between battery cells 900j. Moreover, the effective communication range of optical wireless whisper communication is small (or, very limited), so that the position and disposition sequence of each signal transmission in the battery system 1000, can be one-by-one identified, and it can reduce the difficulty of assembly test and maintenance. In addition, the optical transceiver 400j is not directly connected to the corresponding optical transceivers 400j. The dielectrics between the circuit board BD, such as air, can withstand the high voltage accumulated across the series connection of the battery cells 900j to improve operational safety.

The above disclosure provides different features of some embodiments or examples to implement the present invention. Specific examples of components and configurations (e.g., the values or wordings mentioned) are described above by simplifying/illustrating the implementations of the present invention. Of course, these components and configurations are examples only and are not intended to limit the scope of the present invention. In addition, some embodiments of the present invention may repeat reference symbols and/or letters. This repetition is for simplicity and clarity purposes, and does not limit any relationship between the various embodiments and/or configurations.

In summary, the present invention has been disclosed in the embodiments, which are not intended to limit the implementations of the present invention. Those who have common knowledge in the field of technology to which the present invention belongs, may make modification and embellishments without departing from the scope of the present invention. Therefore, the protection scope of the present invention shall be defined by the claims of the patent invention.

What is claimed is:

1. A battery communication system, including:
at least one monitoring chip, connected to at least one battery cell;
at least one controller; and
at least one radio frequency coupler, disposed adjacent to the monitoring chip, or disposed between the monitoring chip and the controller.

2. The battery communication system according to claim 1, wherein a count number of the at least one monitoring chip is plural, a count number of the at least one battery cell is plural, and a count number of the at least one radio frequency coupler is plural, wherein each of the monitoring chips is respectively connected to one of the battery cells, wherein each of the radio frequency couplers, is disposed between the adjacent monitoring chips, or disposed between the controller and one of the monitoring chips, and a daisy chain communication path is formed through the communication between the radio frequency couplers.

3. The battery communication system according to claim 2, wherein each of the radio frequency couplers, includes:
a circuit board;
a first communication circuit, disposed on the circuit board; and
a second communication circuit, disposed on the circuit board, wherein the first communication circuit and the second communication circuit are respectively connected to the adjacent monitoring chips.

4. The battery communication system according to claim 3, wherein the circuit board of each of the radio frequency couplers is a flexible-printed circuit.

5. The battery communication system according to claim 3, wherein a gap is disposed between the first communication circuit and the second communication circuit of the radio frequency coupler.

6. The battery communication system according to claim 5, wherein a wireless whisper communication is operated between the first communication circuit and the second communication circuit of the radio frequency coupler.

7. The battery communication system according to claim 3, wherein the first communication circuit of each of the radio frequency couplers includes a first node and a second node, and the second communication circuit of each of the radio frequency couplers includes a third node and a fourth node, wherein the first node and the fourth node are separately connected to the adjacent monitoring chips.

8. The battery communication system according to claim 3, wherein the first communication circuit of each of the radio frequency coupler includes: a first metal wire, a second metal wire, and a third metal wire, wherein the first metal wire, the second metal wire, and the third metal wire are connected in sequence, and wherein the first metal wire is substantially perpendicular to the second metal wire, and the second metal wire is substantially perpendicular to the third metal wire; and
wherein the second communication circuit of each of the radio frequency couplers includes: a fourth metal wire, a fifth metal wire, and a sixth metal wire, wherein the fourth metal wire, the fifth metal wire, and the sixth metal wire are connected in sequence, and wherein the fourth metal wire is substantially perpendicular to the fifth metal wire, and the fifth metal wire is substantially perpendicular to the sixth metal wire.

9. The battery communication system according to claim 8, wherein a gap is disposed between the second communication circuit and the fifth communication circuit of the radio frequency coupler.

10. The battery communication system according to claim 8, wherein the widths of the first metal wire, the second metal wire, the third metal wire, the fourth metal wire, the fifth metal wire, and the sixth metal wire, are substantially equivalent.

11. The battery communication system according to claim 8, wherein the lengths of the first metal wire, the third metal wire, the fourth metal wire, and the sixth metal wire of the radio frequency coupler, are substantially equivalent; and the lengths of the second metal wire, and the fifth metal wire of the radio frequency coupler, are substantially equivalent.

12. The battery communication system according to claim 8, wherein a count number of the radio frequency couplers are equivalent to a count number of the monitoring chips.

13. A battery system, includes:
at least one battery cell; and
a battery communication system, including:
at least one monitoring chip, connected to at least one battery cell;
at least one controller; and
at least one radio frequency coupler, disposed adjacent to the monitoring chip, or disposed between the controller and the at least one monitoring chip.

14. The battery system according to claim 13, wherein
a count number of the at least one battery cell being plural, the battery cells being connected in series;
a count number of the at least one monitoring chip being plural, each of the monitoring chips being connected to at least one of the battery cells; and
a count number of at least one radio frequency coupler being plural, wherein each of the radio frequency couplers, is disposed between the adjacent monitoring chips, or disposed between the controller and one of the monitoring chips, and a daisy chain communication path is formed through the communication between the radio frequency couplers.
